(19) United States
(12) Patent Application Publication
(10) Pub. No.: US 2008/0176119 A1
(43) Pub. Date: Jul. 24, 2008

(54) Fuel cell device and electronic equipment

(75) Inventor: Osamu Nakamura, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/006,732

(22) Filed: Jan. 4, 2008

(30) Foreign Application Priority Data
Jan. 24, 2007 (JP) 2007-013458

(51) Int. Cl. H01M 8/06; H01M 8/04; H01M 2/02

(52) U.S. Cl. 429/20; 429/26; 429/19; 429/34

(57) ABSTRACT

Disclosed is a fuel cell device, comprising: a fuel cell to extract electric power by an electrochemical reaction of a fuel and oxygen; a heat exchanger to heat a fluid to be used for the fuel cell by heat of the fuel cell; and a heat insulating container to house the fuel cell and the heat exchanger.

### CROSS-REFERENCE TO RELATED APPLICATIONS

This application is based upon and claims the benefit of priority under 35 USC 119 of Japanese Patent Application No. 2007-13458 filed on Jan. 24, 2007, the entire disclosure of which, including the description, claims, drawings, and abstract, is incorporated herein by reference in its entirety.

### BACKGROUND OF THE INVENTION

1. Field of the Invention

The present invention-relates to a fuel cell which extracts electric power by an electrochemical reaction of a fuel and oxygen, a fuel cell stack, a fuel cell device, and electronic equipment.

2. Description of the Related Art

A fuel cell is one that extracts electric power by an electrochemical reaction of a fuel and oxygen, and research and development of the fuel cell have been widely performed as a power system that will be the main current of the next generation.

As the types of the fuel cell, there are a polymer electrolyte type, a phosphoric acid type, a molten carbonate type, a solid oxide type, or the like. The operating temperature of each type is as follows: about 80° C. in the polymer electrolyte type (or about 120° C. to about 150° C. in the one devised for high temperatures); about 200° C. to about 250° C. in the phosphoric acid type; about 650° C. to about 700° C. in the molten carbonate type; and about 500° C. to about 1,000° C. in the solid oxide type. The power generation performance of a fuel cell remarkably falls at the temperatures lower than these operating temperatures, and at the temperatures higher than these in some cases. Accordingly, keeping the temperature of a fuel cell by housing it in a heat insulating container has been performed (see, for example, Japanese Patent Application Laid-Open Publication No. 2001-229949).

However, when a fuel cell is simply housed in a heat insulating container, the temperature of the fuel cell becomes higher than an appropriate operating temperature owing to the heat generated by the electrochemical reaction of the fuel cell and the power generation performance of the fuel cell may remarkably fall.

### SUMMARY OF THE INVENTION

According to a first aspect of the present invention, a fuel cell device comprises:

a fuel cell to extract electric power by an electrochemical reaction of a fuel and oxygen;

a heat exchanger to heat a fluid to be used for the fuel cell by heat of the fuel cell; and

a heat insulating container to house the fuel cell and the heat exchanger.

According to a second aspect of the present invention, electronic equipment comprises:

a fuel cell device comprising:
a fuel cell to extract the electric power by the electrochemical reaction of the fuel and the oxygen;
a heat exchanger to heat the fluid to be used for the fuel cell by the heat of the fuel cell; and
a heat insulating container to house the fuel cell and the heat exchanger; and

an electronic equipment main body which is operated by the electric power generated by the fuel cell device.

### BRIEF DESCRIPTION OF THE DRAWINGS

The present invention will sufficiently be understood by the flowing detailed description and accompanying drawings, but they are provided for illustration only, and not for limiting the scope of the invention, wherein:

FIG. 1 is a block diagram showing portable electronic equipment 100 mounted with a fuel cell device 1 according to a first embodiment of the present invention;

FIG. 2 is a sectional view showing an internal structure of a heat insulating container 20 of FIG. 1;

FIG. 3 is a graph showing relations between wavelengths and energy densities of black body radiation at a room temperature, 300° C., 600° C., and 900° C.;

FIG. 4 is a graph showing reflectances of infrared rays to wavelengths of Au, Al, Ag, Cu, and Rh;

FIG. 5 is a sectional view showing a modification of the internal structure of the heat insulating container 20;

FIG. 6 is a block diagram showing electronic equipment 100A which is a modification of portable electronic equipment 100 mounted with a direct methanol type fuel cell device 1A;

FIG. 7 is a block diagram showing portable electronic equipment 300 mounted with a fuel cell device 201 according to a second embodiment of the present invention;

FIG. 8 is a sectional view of a vaporizing section 240 or a reforming section 260;

FIGS. 9A, 9B, and 9C are plan views showing three plate materials 310, 320, and 330, respectively, which form the vaporizing section 240 or the reforming section 260;

FIG. 10A is a schematic view showing an internal structure of a heat insulating container 220;

FIG. 10B is a modification of FIG. 10A;

FIG. 11 is a sectional view of a heat exchanger 270;

FIGS. 12A, 12B, and 12C are plan views showing three plate materials 340, 350, and 360, respectively, which form the heat exchanger 270 of FIG. 11;

FIG. 13 is a sectional view of a fuel cell 208;

FIG. 14A is a plan view of a fuel electrode separator 284 seen from the surface on a side where a fuel feeding flow passage 286 is formed;

FIG. 14B is a plan view of an oxygen electrode separator 285 seen from the surface on a side where an oxygen feeding flow passage 287 is formed;

FIG. 15 is a view showing the fuel cells 208 formed in a cell stack;

FIG. 16 is a block diagram showing portable electronic equipment 500 mounted with a fuel cell device 401 according to a third embodiment of the present invention;

FIG. 17 is a schematic view showing an internal structure of a heat insulating container 410;

FIG. 18 is a schematic view showing a modification of the internal structure of the heat insulating container 410;

FIG. 19 is a schematic view showing another modification of the internal structure of the heat insulating container 410;

FIG. 20 is a schematic view showing a further modification of the internal structure of the heat insulating container 410; and

FIG. 21 is a schematic view showing a still further modification of the internal structure of the heat insulating container 410.

### DETAILED DESCRIPTION OF THE PREFERRED EMBODIMENTS

Embodiments of the present invention will be explained with reference to the drawings.

### First Embodiment

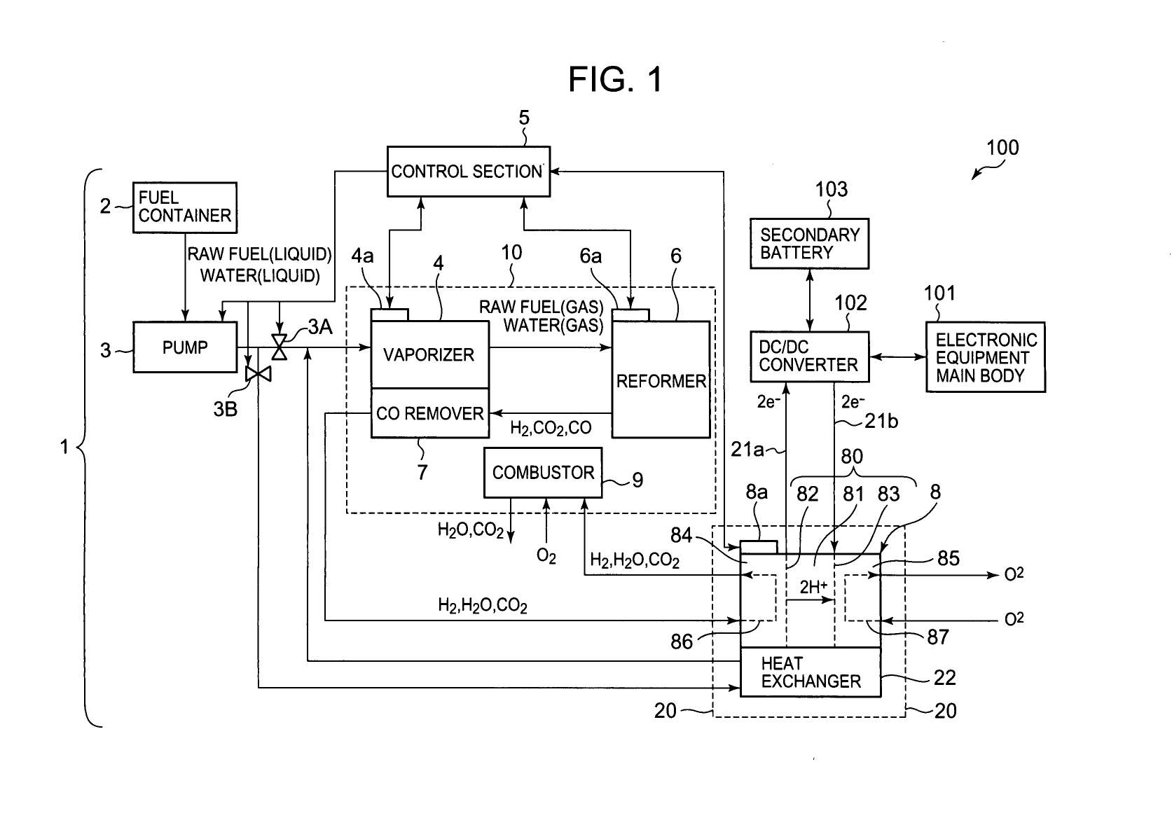

FIG. 1 is a block diagram showing portable electronic equipment 100 mounted with a fuel cell device 1 according to a first embodiment of the present invention. The electronic equipment 100 is the portable type one such as a notebook-size personal computer, a personal digital assistant (PDA), an electronic personal organizer, a digital camera, a cellular phone handset, a wrist watch, a register, a projector or the like.

The electronic equipment 100 comprises the fuel cell device 1, a DC/DC converter 102 to convert the electric energy generated by the fuel cell device 1 into an adequate voltage, a secondary battery 103 connected to the DC/DC converter 102, and an electronic equipment main body 101 to which the electric energy is supplied from the DC/DC converter 102.

As described below, the fuel cell device 1 generates electric energy and outputs the generated electric energy to the DC/DC converter 102. The DC/DC converter 102 is configured to perform the function of converting the electric energy generated by the fuel cell device 1 into an adequate voltage to supply the voltage to the electronic equipment main body 101 after the conversion. The DC/DC converter 102 further performs the function of charging the secondary battery 103 with the electric energy generated by the fuel cell device 1 to supply the electric energy charged in the secondary battery 103 to the electronic equipment main body 101 when the fuel cell device 1 does not operate.

Next, the fuel cell device 1 is described in detail. The fuel cell device 1 comprises a fuel container 2, a pump 3, heat insulating containers 10 and 20, a control section 5 or the like. The fuel container 2 of the fuel cell device 1 is provided to the electronic equipment 100 in a detachably attachable state, and the pump 3 and the heat insulating containers 10 and 20 are incorporated in the main body of the electronic equipment 100. The control section 5 controls operations of the pump 3, each of the later described electric heater-cum-temperature sensors 4a, 6a and 8a, valves 3A, and 3B or the like, based on electric signals from each of the electric heater-cum-temperature sensors 4a, 6a and 8a.

The fuel container 2 reserves a mixed liquid of a liquid raw fuel (such as methanol, ethanol, or dimethyl ether) and water. Incidentally, the liquid raw fuel and the water may be reserved in separate containers.

The pump 3 is the one for sucking the mixed liquid in the fuel container 2 to send the mixed liquid to a vaporizer 4 in the heat insulating container 10 or a heat exchanger 22 in the heat insulating container 20. Incidentally, the valve 3A is provided in the flow passage from the pump 3 to the vaporizer 4, and the valve 3B is provided in the flow passage from the pump 3 to the heat exchanger 22.

The barometric pressure in the sealed box-shaped heat insulating container 10 is kept to be lower than an atmospheric pressure (for example, 10 Pa or less), and the vaporizer 4, a reformer 6, a CO remover 7, and a combustor 9 are housed inside the heat insulating container 10.

Moreover, electric heater-cum-temperature sensors 4a and 6a are provided to the vaporizer 4 and the reformer 6, respectively. Because the electric resistance values of the electric heater-cum-temperature sensors 4a and 6a depend on temperature, the electric heater-cum-temperature sensors 4a and 6a function as heaters to heat the vaporizer 4 and the reformer 6, respectively, and also function as temperature sensors to measure the temperatures of the vaporizer 4 and the reformer 6, respectively.

The vaporizer 4 heats the mixed liquid sent from the pump 3 to a temperature within a range from about 110° C. to about 160° C. by the heat generated by the electric heater-cum-temperature sensor 4a and the combustor 9, and the heat transferred from the reformer 6 to vaporize the mixed liquid. The gas mixture vaporized by the vaporizer 4 is sent to the reformer 6.

A catalyst is carried on the wall surface of a flow passage inside the reformer 6. The reformer 6 heats the gas mixture sent from the vaporizer 4 by the heat of the electric heater-cum-temperature sensor 6a and the combustor 9 to a temperature within a range from about 300° C. to about 400° C., and causes a reforming reaction by the catalyst in the flow passage. That is, a gas mixture (reformed gas) including hydrogen as a fuel and carbon dioxide, and a slight amount of carbon monoxide which is a by-product, is generated by a catalytic reaction of the raw fuel and the water. Incidentally, when the raw fuel is methanol, a steam reforming reaction as shown in the following formula (1) is chiefly caused in the reformer 6.

CH₃OH+H₂O→3H₂+CO₂ (1)

The carbon monoxide is slightly produced as a by-product in accordance with the following formula (2) which is caused successively to the chemical reaction formula (1).

H₂+CO₂→H₂O+CO (2)

The CO remover 7 removes the CO produced by the reaction expressed by the formula (2) in the reformer 6 by a reaction expressed by a formula (3).

CO+½O₂→CO₂ (3)

The reaction of the CO remover 7 is performed at a temperature within a range from about 110° C. to about 160° C. Incidentally, the CO remover 7 is provided integrally with the vaporizer 4, and is heated by the heat generated by the electric heater-cum-temperature sensor 4a and the combustor 9, and the heat transferred from the reformer 6.

The reformed gas from which the CO has been removed is supplied to a fuel cell 8.

The reformed gas (exhaust gas 1) that has passed through the fuel cell 8 and oxygen are supplied to the combustor 9, and the combustor 9 burns unreacted hydrogen. The combustion heat is used for heating the vaporizer 4, the reformer 6, and the CO remover 7.

The barometric pressure in the sealed box-shaped heat insulating container 20 is kept to be lower than the atmospheric pressure (for example, 10 Pa or less), and the fuel cell 8 and the heat exchanger 22 are housed inside the heat insulating container 20.

The fuel cell 8 is a polymer electrolyte fuel cell, and comprises a membrane electrode assembly 80 which comprises a hydrogen ion permeable electrolyte membrane 81, a fuel electrode 82 (anode), and an oxygen electrode 83 (cathode). The fuel electrode 82 and the oxygen electrode 83 are formed on both the surfaces of the electrolyte membrane 81. The fuel cell 8 further comprises a fuel electrode separator 84 in which a fuel feeding flow passage 86 to supply a reformed gas to the fuel electrode 82 is formed, and an oxygen electrode separator 85 in which an oxygen feeding flow passage 87 to supply oxygen to the oxygen electrode 83 is formed.

The reaction of the formula (4) is caused in the fuel electrode 82, and the reaction of the formula (5) is caused in the oxygen electrode 83. The electrons generated by the fuel electrode 82 arrive at the oxygen electrode 83 through an anode output electrode 21a, the DC/DC converter 102, and a cathode output electrode 21b.

H₂→2H⁺+2e⁻ (4)

2H⁺+2e⁻+½O₂→H₂O (5)

Moreover, the fuel cell 8 is provided with an electric heater-cum-temperature sensor 8a. The electric resistance value of the electric heater-cum-temperature sensor 8a depends on temperature. The electric heater-cum-temperature sensor 8a functions as a heater for heating the fuel cell 8, and also functions as a temperature sensor to measure the temperature of the fuel cell 8. Here, the measured temperature is sent to the control section 5 as the electric signal.

The operation of the fuel cell 8 is performed at a temperature of about 80° C.

The reformed gas (exhaust gas 1) that has passed through the fuel feeding flow passage 86 of the fuel cell 8 is supplied to the combustor 9.

The heat exchanger 22 is provided integrally with the fuel cell 8. The heat exchanger 22 makes the mixed liquid on the way of being supplied from the pump 3 to the vaporizer 4 absorb the heat generated by the fuel cell 8 at the time of a steady operation, and thereby cools the fuel cell 8 and heats the mixed liquid.

Next, the concrete configuration of the inside of the heat insulating container 20 is described.

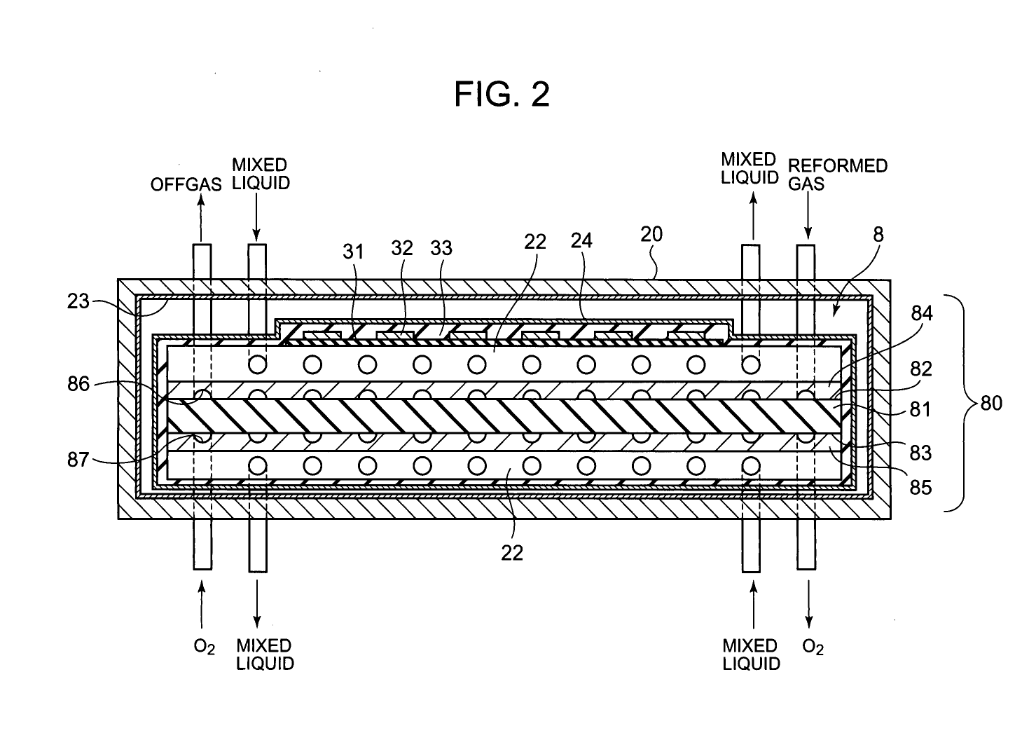

FIG. 2 is a sectional view showing the internal structure of the heat insulating container 20 of FIG. 1. As shown in FIG. 2, the fuel cell 8 is provided inside the heat insulating container 20, and the heat exchanger 22 is provided on both the surfaces of the fuel electrode separator 84 side and the oxygen electrode separator 85 side. On the surface of the heat exchanger 22, a thin film heater 32 to be the electric heater-cum-temperature sensor 8a is formed with an insulation film 31 put between them. The thin film heater 32 is covered by an insulation film 33.

An infrared ray reflecting film 23 is provided on the internal wall surface of the heat insulating container 20. Moreover, an infrared ray reflecting film 24 is provided through the above described insulation film 33 on the external wall surfaces of the fuel cell 8 and of the heat exchanger 22 as the need arises. The infrared ray reflecting films 23 and 24 inhibit the heat transfer caused by radiation. Incidentally, because the insulation film 33 exists, the infrared ray reflecting film 24 is not conducted to the thin film heater 32, the fuel electrode separator 84, and the oxygen electrode separator 85.

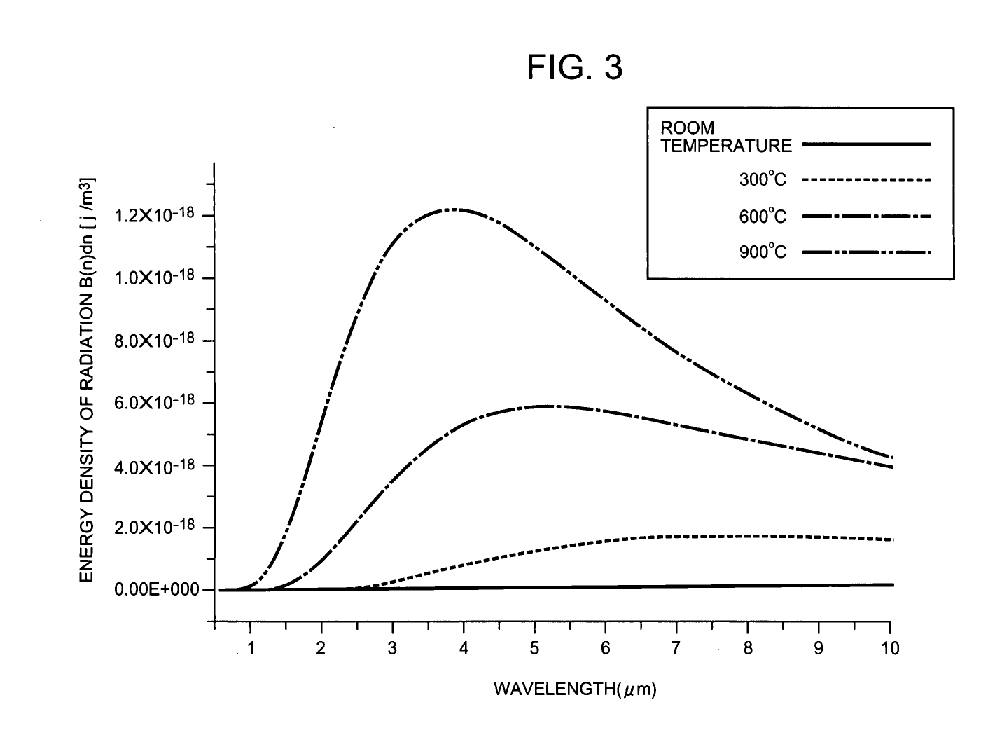

The wavelength of an electromagnetic wave radiated from the fuel cell 8 and the heat exchanger 22 is examined. FIG. 3 is a graph showing the relations between the wavelength of black body radiation and the energy density of the radiation at room temperatures of 300° C., 600° C., and 900° C. It can be known that the energy density of the radiation becomes high at the wavelength of 2 82 m or longer at the temperature of 300° C.; that the energy density of the radiation becomes high at the wavelength of 1.24 μm or longer at the temperature of 600° C.; and that the energy density of the radiation becomes high at the wavelength of 1 μm or longer at the temperature of 900° C. It is accordingly required that the reflectances of the infrared ray reflecting films 23 and 24 are high to the infrared rays having the wavelengths of 1 μm or longer.

Next, the materials of the infrared ray reflecting films 23 and 24 are examined.

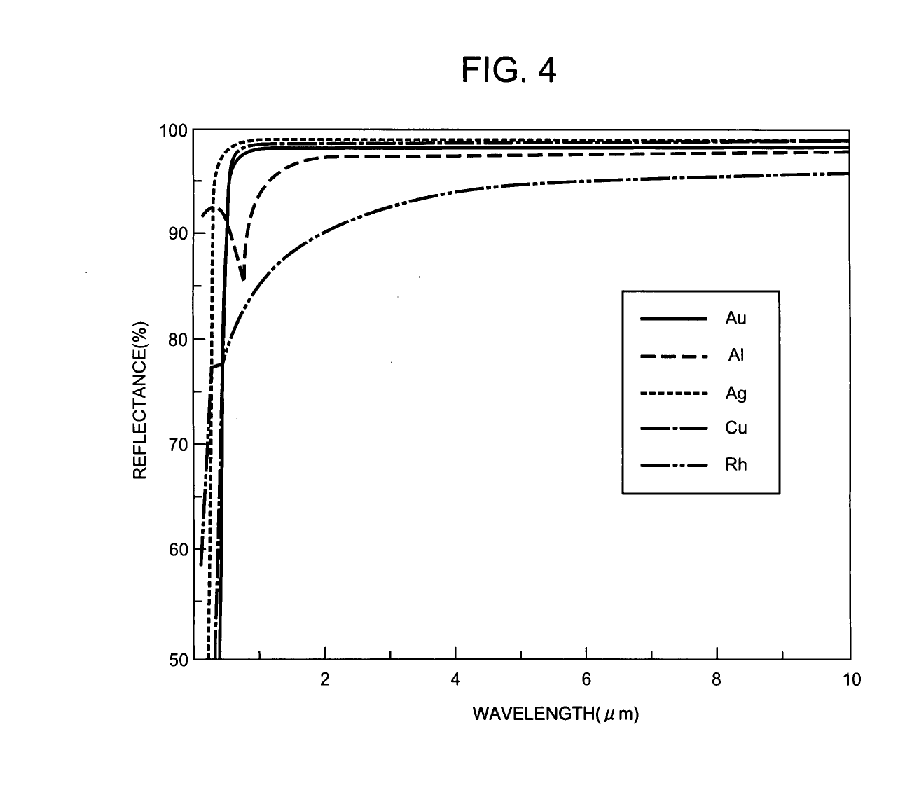

FIG. 4 shows reflectances of the infrared rays of Au, Al, Ag, Cu, and Rh to wavelengths. Among them, Au and Ag can be cited as the metals having high reflectances in the wavelength ranges of 1 μm or longer, and they can be used as the materials of the infrared ray reflecting films 23 and 24.

Next, the operation of the fuel cell device 1 is described.

By the control section 5, the vaporizer 4, the reformer 6, the CO remover 7, and the fuel cell 8 are first heated to appropriate operating temperatures being conducted to the electric heater-cum-temperature sensors 4a, 6a, and 8a. Because the vaporizer 4, the reformer 6, the CO remover 7, and the fuel cell 8 are housed inside the heat insulating containers 10 and 20, the heat generated by the electric heater-cum-temperature sensors 4a, 6a, and 8a is efficiently used to heat the vaporizer 4, the reformer 6, the CO remover 7, and the fuel cell 8, and can rapidly raise their temperatures to the appropriate operating temperatures.

Next, the pump 3 is driven by the control section 5 in the state in which the valve 3A is opened and the valve 3B is closed, and the mixed liquid inside the fuel container 2 is thereby supplied to the vaporizer 4. The mixed liquid vaporized by the vaporizer 4 is reformed in the reformer 6, and the carbon monoxide included in the reformed gas is removed by the CO remover 7. After that, the reformed gas is supplied to the fuel feeding flow passage 86 of the fuel cell 8.

On the other hand, a not-shown air pump is driven by the control section 5, and oxygen is supplied to the oxygen feeding flow passage 87 of the fuel cell 8. The oxygen may be supplied through introduced air. Alternatively, the oxygen may be supplied to the oxygen feeding flow passage 87 of the fuel cell 8 from a container in which oxygen is stored through an air pump.

The reformed gas supplied to the fuel cell 8 is used for an electrochemical reaction to extract electric power. The exhaust gas 1 after the extraction is burned in the combustor 9.

After a little while from starting the operation of the fuel cell device 1, the temperature of the fuel cell 8 rises by the heat generated by the electrochemical reaction, and the temperature may exceed an appropriate operating temperature when the operation is continued as it is. Accordingly, when the valve 3A is closed and the valve 3B is opened by the control section 5 before the temperature of the fuel cell 8 becomes higher than the appropriate operating temperature, the mixed liquid is supplied to the vaporizer 4 through the heat exchanger 22. The fuel cell 8 is cooled by the mixed liquid flowing through the heat exchanger 22. On the other hand, the mixed liquid is heated by flowing through the heat exchanger 22.

In this manner, the fuel cell 8 and the heat exchanger 22 are provided integrally. The excessive heat generated by the fuel cell 8 can be used to heat the mixed liquid by the heat exchanger 22, and the fuel cell 8 housed in the heat insulating container 20 can be kept at an appropriate operating temperature.

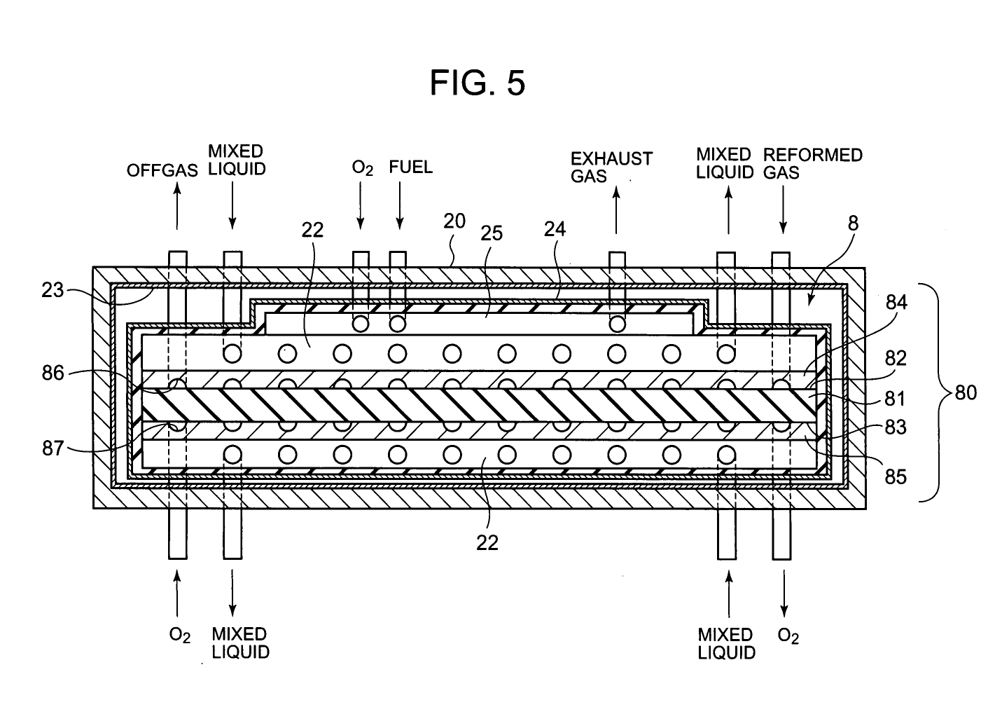

Incidentally, as shown in FIG. 5, a combustor 25 to heat the fuel cell 8 may be provided on the surface of the heat exchanger 22. In this case, the fuel supplied to the combustor 25 may be the mixed liquid supplied from the pump 3, or may be the exhaust gas 1. Further, in the same manner as the above described first embodiment, the infrared ray reflecting film 24 is also provided on external wall surfaces of the fuel cell 8 and of the combustor 25 through the insulation film 33 when necessary. Also in this case, because the insulation film 33 exists, the infrared ray reflecting film 24 is not conducted to the combustor 25, the fuel electrode separator 84, and the oxygen electrode separator 85.

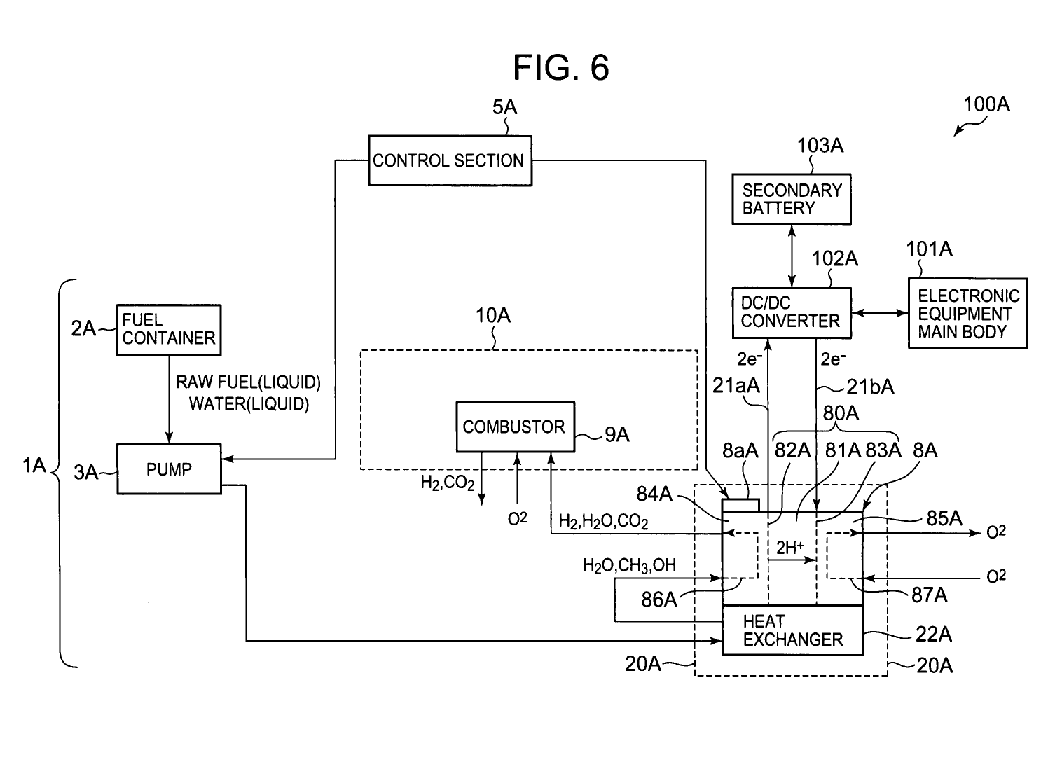

Moreover, although the reforming type fuel cell device has been described in the above embodiment, the present invention may be applied to a direct methanol type fuel cell device 1A which supplies fuel to the fuel cell directly, as shown in FIG. 6. That is, the mixed liquid heated by the heat exchanger 22A may directly be supplied to the direct methanol type fuel cell 8A.

### Second Embodiment

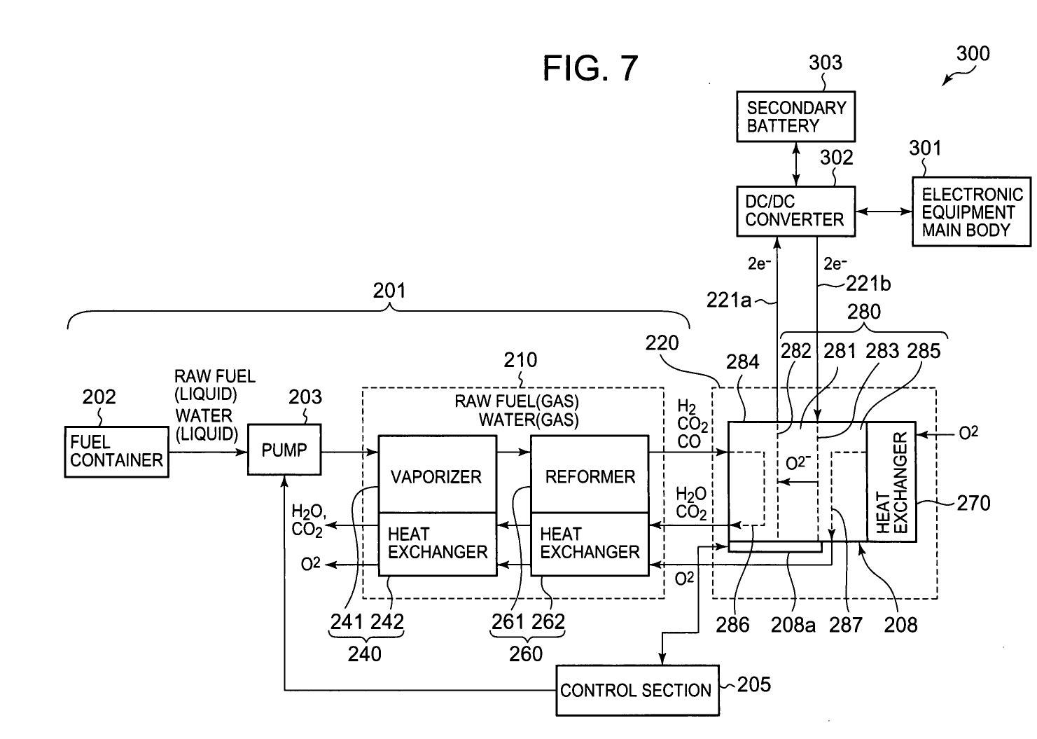

Next, a second embodiment of the present invention is described. FIG. 7 is a block diagram showing portable electronic equipment 300 mounted with a fuel cell device 201 according to a second embodiment of the present invention.

The electronic equipment 300 comprises an electronic equipment main body 301, a DC/DC converter 302, a secondary battery 303, and the fuel cell device 201 to supply electric power to them, which are similar to those of the electronic equipment 100 of the first embodiment.

A solid oxide type fuel cell 208 is used as the fuel cell device 201 of the present embodiment, and comprises a fuel container 202, a pump 203, heat insulating containers 210 and 220, a control section 205 or the like, which are similar to those of the first embodiment.

The barometric pressures in the sealed box-shaped heat insulating containers 210 and 220 are kept to be lower than the atmospheric pressure (for example, 10 Pa or less). A vaporizing section 240 and a reforming section 260 are housed in the heat insulating container 210, and a fuel cell 208 and a heat exchanger 270 are housed in the heat insulating container 220.

The vaporizing section 240 is integrally provided with a vaporizer 241 and a heat exchanger 242, and the reforming section 260 is integrally provided with a reformer 261 and a heat exchanger 262. The reactions performed in the vaporizer 241 and the reformer 261 are similar to those performed in the vaporizer 4 and the reformer 6 of the first embodiment, respectively.

The reformed gas (exhaust gas 1), which has passed through the fuel cell 208, and air (exhaust gas 2) are discharged to the outside of the heat insulating container 220, and are successively introduced into the heat insulating container 210.

Discharge flow passages of the exhaust gases 1 and 2 are formed in the heat exchangers 242 and 262. The exhaust gases 1 and 2 are discharged to the outside of the heat insulating container 210 through the discharge flow passages formed in the heat exchangers 242 and 262. The heat exchangers 242 and 262 raise the temperatures of the vaporizer 241 and the reformer 261, respectively, by the heat discharged when the exhaust gases 1 and 2 pass through them.

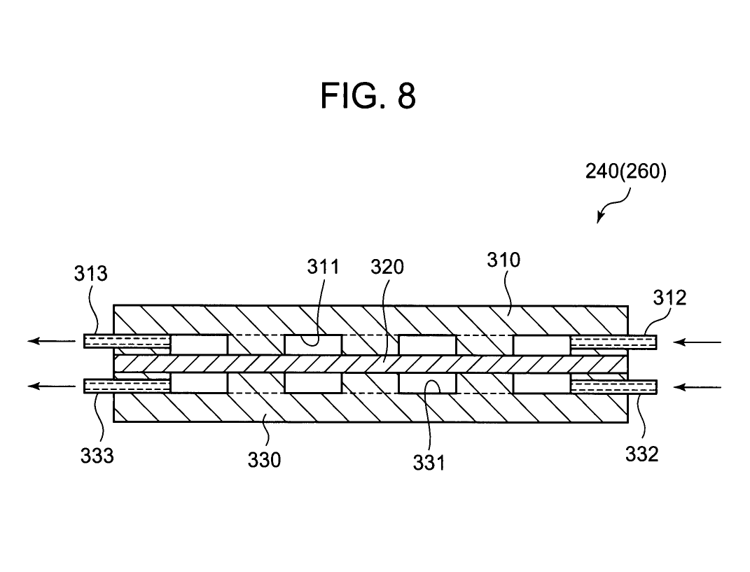

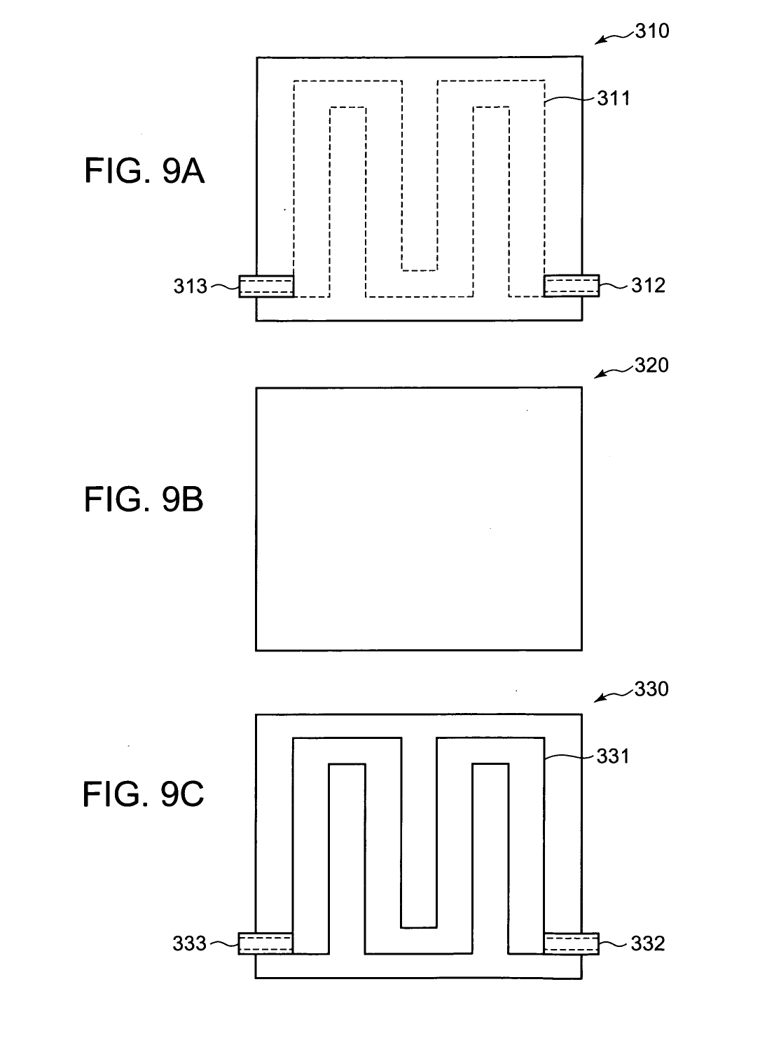

FIG. 8 is a sectional view of the vaporizing section 240 or the reforming section 260, and FIGS. 9A to 9C are plan views showing three plate materials 310, 320, and 330 forming the vaporizing section 240 or the reforming section 260, respectively.

Winding grooves 311 and 331 are formed in the plate materials 310 and 330, respectively, to be mutually opposed.

The groove 311 functions as the reaction flow passage of the vaporizer 241 or the reformer 261, and pipes 312 and 313 connected to other reactors or the like (the pump 203, the vaporizing section 240, the reforming section 260, and the fuel cell 208) are provided on both ends of the groove 311.

The groove 331 functions as a discharge flow passage in the heat exchanger 242 or 262, and pipes 332 and 333 connected to other reactors or the like (the pump 203, the vaporizing section 240, the reforming section 260, and the fuel cell 208) are provided on both ends of the groove 331.

The plate material 310 is joined on one surface of the center partition plate 320, and the plate material 330 is joined on the other surface of the partition plate 320 in a state where the sides of the grooves 311 and 331 are facing the side of the partition plate 320, respectively.

Incidentally, when a porous body for vaporizing the mixed liquid is filled up in the groove 311 in the above structure, the groove 311 functions as the vaporizing section 240. On the other hand, when a catalyst of a reforming reaction is carried on the wall surface of the groove 311 in the above structure, the groove 311 functions as the reforming section 260.

In this manner, the vaporizer 241 or the reformer 261, and the discharge flow passages are disposed on both the surfaces of the partition plate 320, and heat is thereby drawn away from the exhaust gasses 1 and 2 passing through the discharge flow passages. Consequently, the heat can be used for the vaporization of the mixed liquid flowing through the vaporizer 241 and for the reforming reaction in the reformer 261.

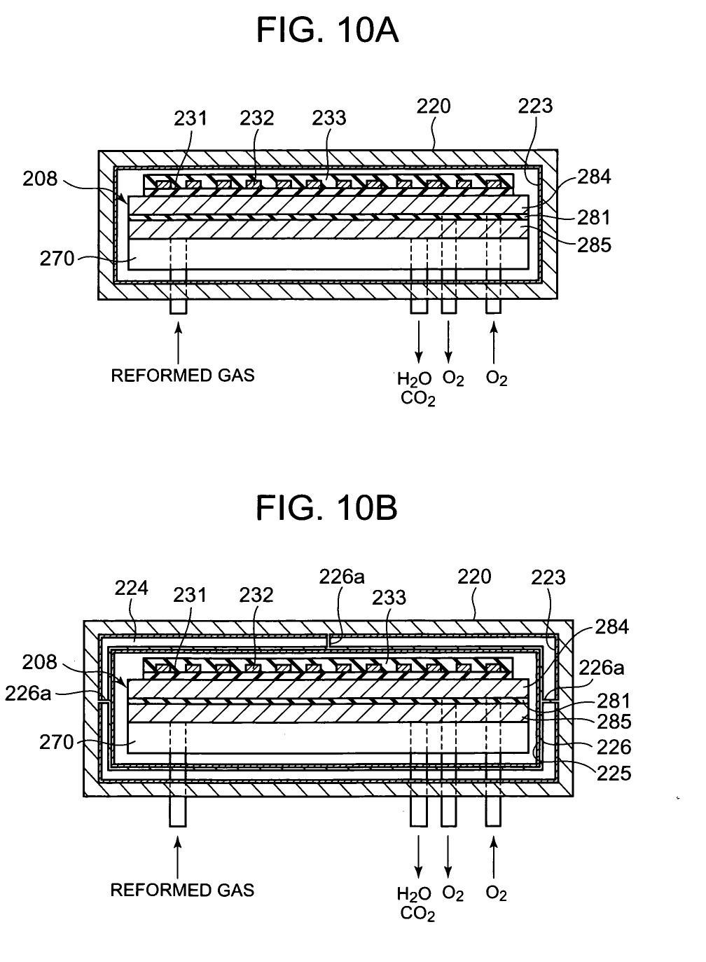

FIG. 10A is a schematic view showing the internal structure of the heat insulating container 220. An infrared ray reflecting film 223 is provided on the internal wall surface of the heat insulating container 220. As the infrared ray reflecting film 223, the materials similar to those of the reflecting films 23 and 24 can be used. Incidentally, an infrared ray reflecting film 224 may be provided on the external wall surfaces of the fuel cell 208 and the heat exchanger 270, too through an insulation film 233. In the same manner as the above described first embodiment, because the insulation film 233 exists, the infrared ray reflecting film 224 is not conducted to a thin film heater 232, the fuel electrode separator 284, and the oxygen electrode separator 285.

Moreover, because the reaction temperature of the fuel cell 208 is within a range from about 500° C. to about 1,000° C. and the energy density of radiation is high, a gap 224 may be formed inside the infrared ray reflecting film 223 to provide a second infrared ray reflecting film 225 as shown in FIG. 10B. The second infrared ray reflecting film 225 is formed on, for example, the internal wall surface of a case (heat insulating container) 226 made of the same material as that of the heat insulating container (a second heat insulating container) 220, and is supported by a supporting member 226a. In this case, the internal pressure of the case 226 is kept to be lower than the atmospheric pressure (for example, 10 Pa or less) as in the inside of the heat insulating container 220. By forming the gap 224, the heat conduction from the second infrared ray reflecting film 225 to the first infrared ray reflecting film 223 can be prevented, and heat-insulating efficiency can thereby be heightened.

The thin film heater 232 functioning as an electronic heater-cum-temperature sensor 208a is formed on the fuel cell 208 with an insulation film 231 put between them. The thin film heater 232 is covered by the insulation film 233. Because the electric resistance value of the electronic heater-cum-temperature sensor 208a depends on temperature, the electronic heater-cum-temperature sensor 208a also functions as a temperature sensor to measure the temperature of the fuel cell 8. Here, the measured temperature is sent to the control section 205 as the electric signal.

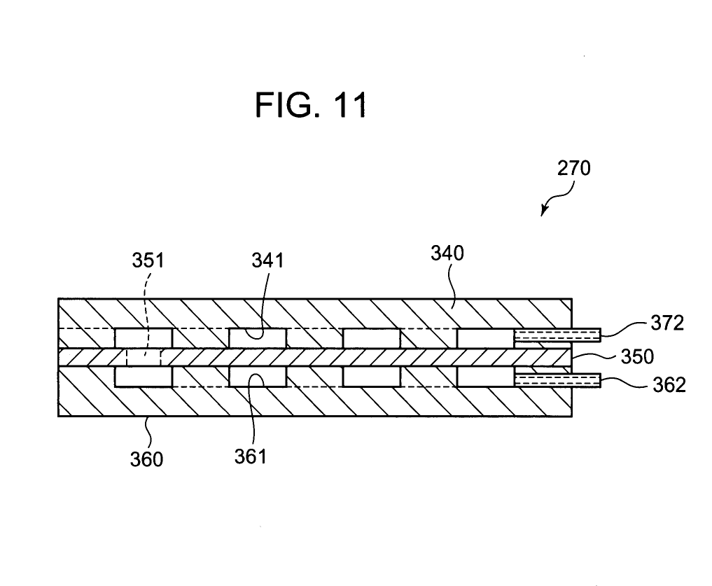

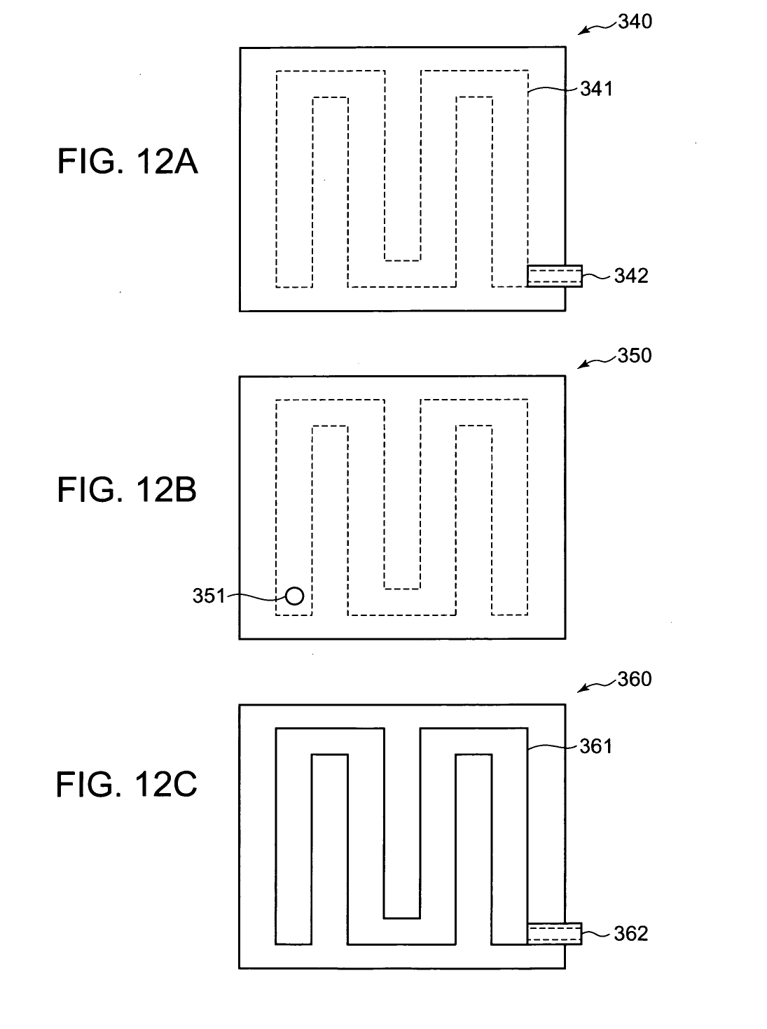

FIG. 11 is a sectional view of the heat exchanger 270, and FIGS. 12A-12C are plan views showing three plate materials 340, 350, and 360 forming the heat exchanger 270, respectively.

Winding grooves 341 and 361 to function as the flow passages of the air to be supplied to the fuel cell 208 are formed in the plate materials 340 and 360, respectively, to be mutually opposed. Pipes 342 and 362 to be connected to the fuel cell 208 or a not-shown air supplying flow passage are provided on one side ends of the grooves 341 and 361.

The plate material 340 is joined on one surface of the center partition plate 350, and the plate material 360 is joined on the other surface of the partition plate 350 in a state where the sides of the grooves 341 and 361 are facing the side of the partition plate 350, respectively. Moreover, a through-hole 351 is formed in the partition plate 350 at a position corresponding to the end on the side opposite to the side on which the pipes 342 and 362 of the grooves 341 and 361, respectively, are provided. The grooves 341 and 361 are mutually connected by the through-hole 351 to be formed as a series of flow passage of air.

The heat exchanger 270 fulfills the role of previously heating the air to be supplied to the fuel cell 208 by the heat generated by the fuel cell 208 and the electronic heater-cum-temperature sensor 208a.

The fuel cell 208 is heated to a temperature within a range from about 500° C. to about 1,000° C. by the heat of the electronic heater-cum-temperature sensor 208a, and performs an electrochemical reaction to be described below.

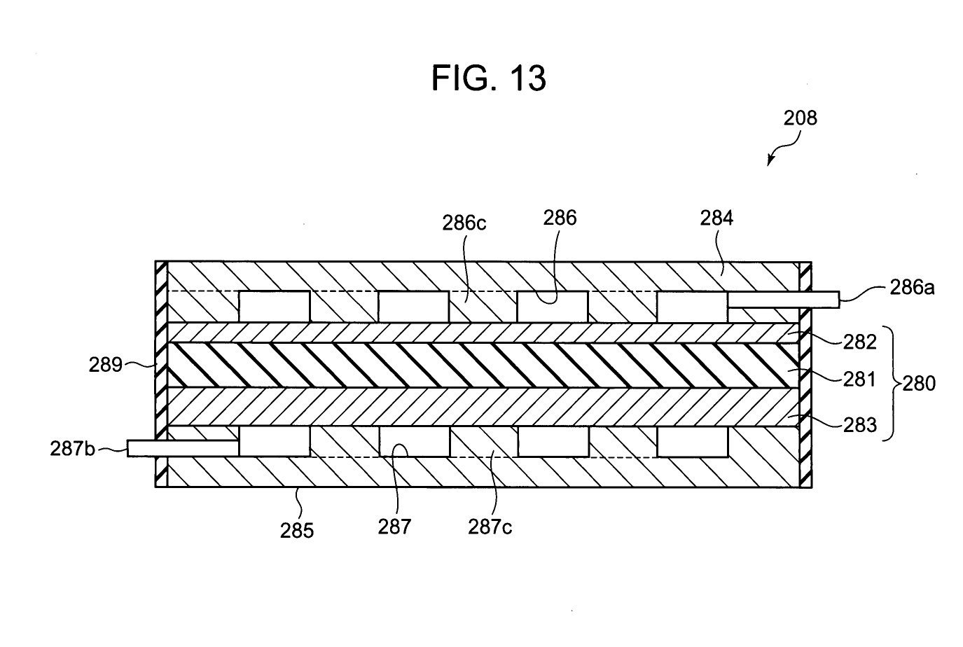

FIG. 13 is a sectional view of the fuel cell 208. The fuel cell 208 is a solid oxide type fuel cell. The fuel cell 208 comprises a single cell 280 including a fuel electrode 282 (anode) and an oxygen electrode 283 (cathode), which are formed on both the surfaces of a solid oxide electrolyte 281. The fuel electrode separator 284 provided with a fuel feeding flow passage 286 to supply a reformed gas to the fuel electrode 282 and the oxygen electrode separator 285 provided with an oxygen feeding flow passage 287 to supply oxygen to the oxygen electrode 283 are stacked, and a sealing medium 289 seals the periphery of the fuel cell 208.

The electronic heater-cum-temperature sensor 208a is formed on the external surface of either fuel electrode separator 284 or the oxygen electrode separator 285, and the heat exchanger 270 is formed integrally with the other external surface.

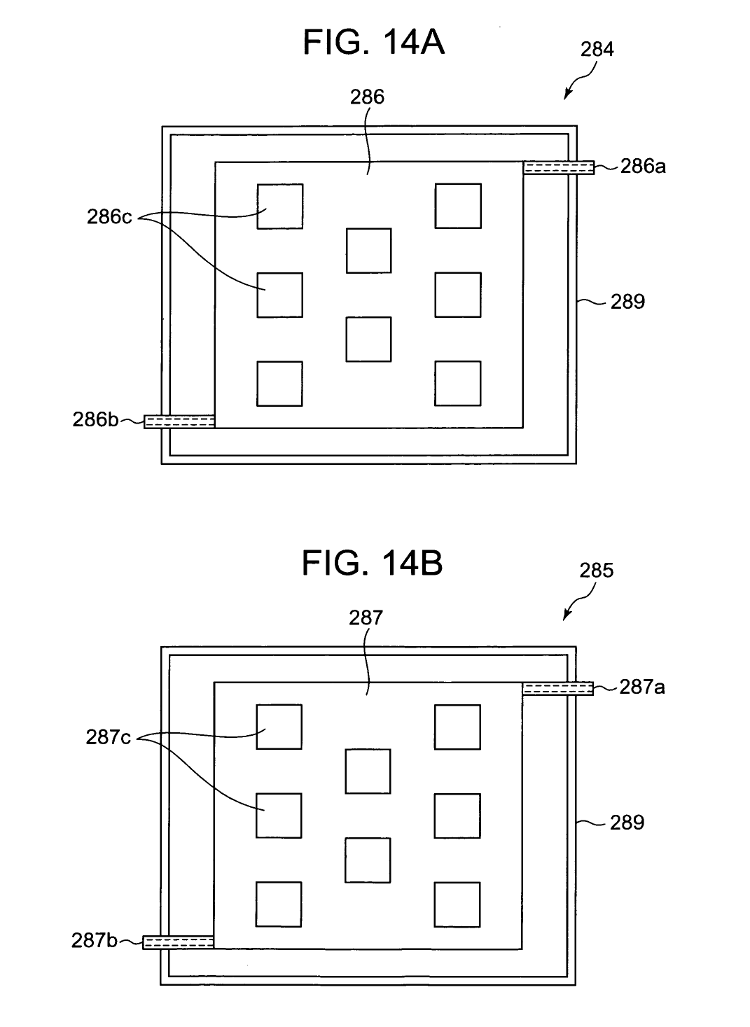

FIG. 14A is a plan view of the fuel electrode separator 284 seen from the surface on the side where the fuel feeding flow passage 286 is formed, and FIG. 14B is a plan view of the oxygen electrode separator 285 seen from the surface on the side where the oxygen feeding flow passage 287 is formed. The fuel feeding flow passage 286 and the oxygen feeding flow passage 287 are respectively formed in a rectangular shape, and pipes 286a, 286b, 287a, and 287b which function as influx and efflux sections of gasses, are provided on diagonal positions.

Moreover, the insides of the fuel feeding flow passage 286 and the oxygen feeding flow passage 287 form flow passages, and props 286c and 287c supporting the fuel electrode 282 and the oxygen electrode 283, respectively, are provided. By the props 286c and 287c, the fuel feeding flow passage 286 between the fuel electrode 282 and the fuel electrode separator 284, and the oxygen feeding flow passage 287 between the oxygen electrode 283 and the oxygen electrode separator 285 are ensured.

(La₁₋ₓ, Srₓ)(Cr_{1-y}Mg_{y})O₃, (La₁₋ₓ, Srₓ)CrO₃, Fe—Cr alloy, or the like, can be used as the fuel electrode separator 284 and the oxygen electrode separator 285.

The air heated by the heat exchanger 270 is sent to the oxygen electrode 283 through the oxygen feeding flow passage 287. At the oxygen electrode 283, oxygen ions are generated by the oxygen in the air and the electrons supplied from a cathode output electrode 221b as shown in the following formula (3).

O₂+4e⁻→2O²⁻ (3)

La(Ni₁₋ₓ, Feₓ)O₃, (La₁₋ₓ, Srₓ)MnO₃, (La₁₋ₓSrₓ)CoO₃, or the like, can be used as the oxygen electrode 283.

The solid oxide electrolyte 281 has oxygen ion permeability, and transmits the oxygen ions generated by the oxygen electrode 283 to make the oxygen ions arrive at the fuel electrode 282. Zirconia series (Zr₁₋ₓYₓ)O_{2-x/2}(YSZ), lanthanum gallate series (La₁₋ₓSrₓ)(Ga_{1-y-z}Mg_{y}Co_{z})O₃, or the like, can be used as the solid oxide electrolyte 281.

The reformed gas supplied from the reformer 261 through the fuel feeding flow passage 286 is sent to the fuel electrode 282. At the oxygen electrode 283, the reactions shown by the following formula (4) and (5) of the oxygen that has transmitted the solid oxide electrolyte 281 and the reformed gas are caused.

H₂+O²⁻→H₂+2e⁻ (4)

CO+O²⁻→CO₂+2e⁻ (5)

Ni, Ni+YSZ, or the like can be used as the fuel electrode 282.

The fuel electrode 282 is connected to an anode output electrode 221a to conduct it, and the oxygen electrode 283 is connected to the cathode output electrode 221b to conduct it. Because the anode output electrode 221a and the cathode output electrode 221b are connected to the DC/DC converter 302, the electrons generated by the fuel electrode 282 are supplied to the oxygen electrode 283, through the anode output electrode 221a, external circuits such as the DC/DC converter 302, and the cathode output electrode 221b.

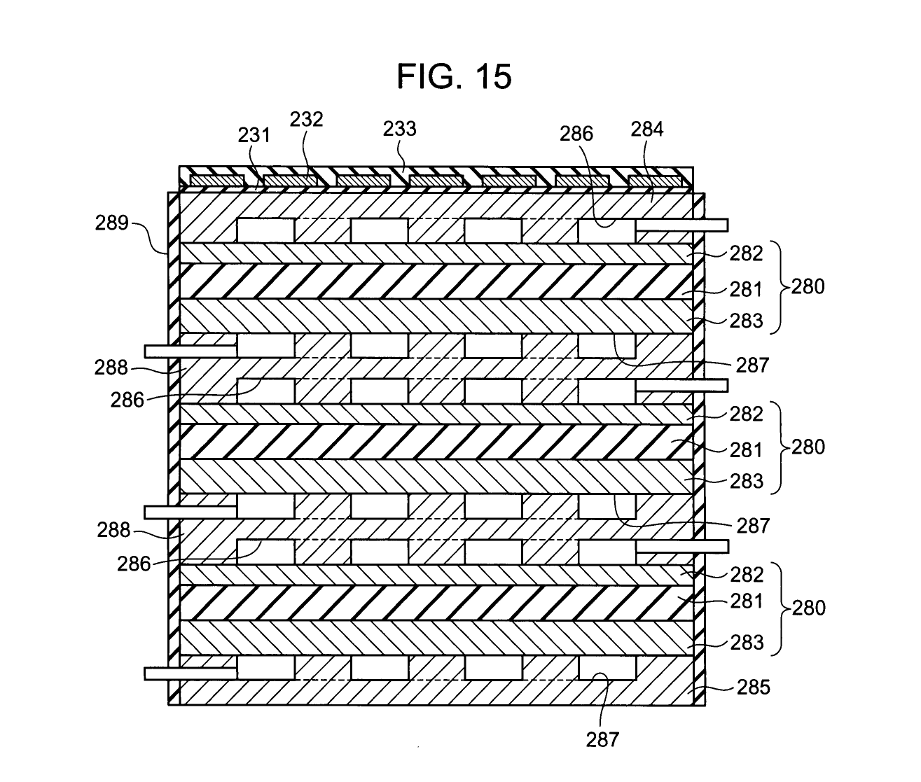

Moreover, as shown in FIG. 15, the fuel cell may be formed as a cell stack in which the single cells 280 are stacked. In each of the single cells 280, the fuel electrode 282 (anode) and the oxygen electrode 283 (cathode) are formed on both the surfaces of the solid oxide electrolyte 281. In this case, an inter-connector 288 including the fuel feeding flow passage 286 formed on one surface and the oxygen feeding flow passage 287 formed on the other surface is disposed between each of the single cells 280 so that the side of the fuel feeding flow passage 286 is opposed to the fuel electrode 282 and the side of the oxygen feeding flow passage 287 is opposed to the oxygen electrode 283. La(Cr₁₋ₓMgₓ)O₃, (La₁₋ₓ, Srₓ)CrO₃, or the like, can be used as the inter-connector 289.

Incidentally, when the fuel cell is formed as the cell stack, the electronic heater-cum-temperature sensor 208a is formed on the external surface of either of the fuel electrode separator 284 and the oxygen electrode separator 285 on both the ends, and the heat exchanger 270 is integrally formed on the other surface.

As described above, in the second embodiment of the invention, because the fuel cell 208 and the heat exchanger 270 are integrally formed, the excessive heat generated by the fuel cell 208 can be used to heat the mixed liquid by the heat exchanger 270, and the fuel cell 208 housed in the heat insulating container 220 can be kept at an appropriate operating temperature. In particular, because the fuel cell 208 of the present embodiment is a solid oxide type fuel cell and the operating temperature thereof is higher than that of the polymer electrolyte fuel cell, the heat of the fuel cell is effectively used to enable heightening the thermal efficiency of the fuel cell device.

### Third Embodiment

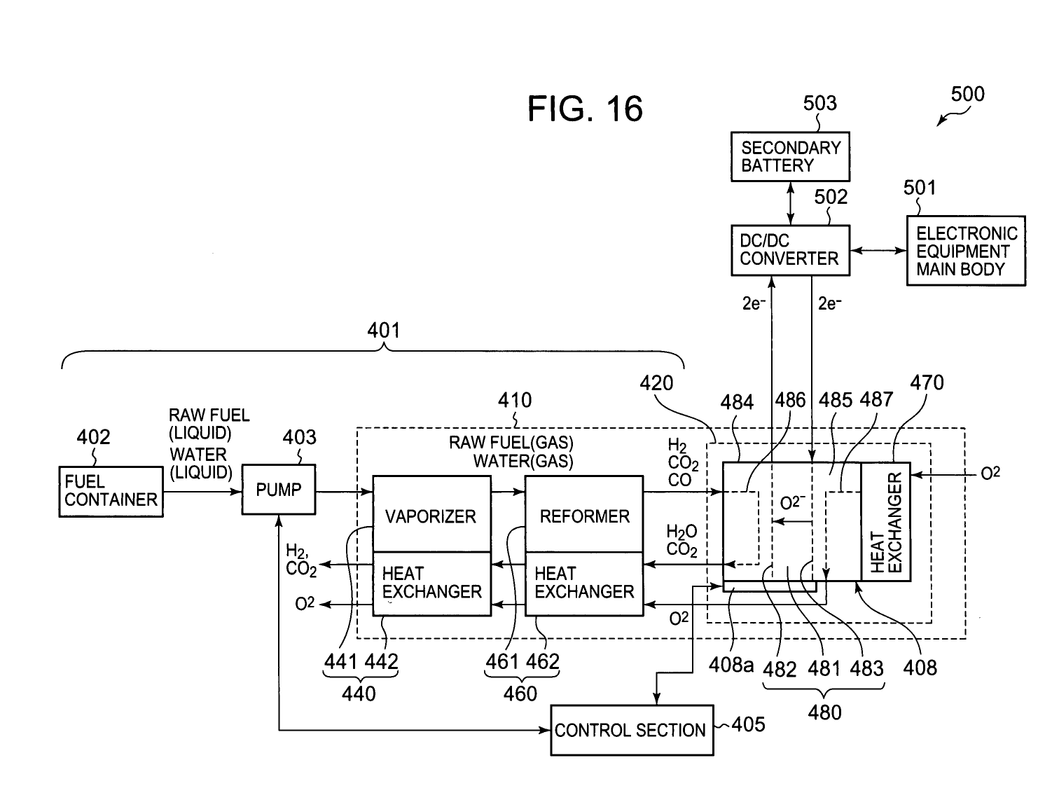

Next, a third embodiment of the present invention is described. FIG. 16 is a block diagram showing portable electronic equipment 500 mounted with a fuel cell device 401 according to the third embodiment of the present invention.

The present embodiment is different from the second embodiment in that a heat insulating container 420 housing a fuel cell 408 and a heat exchanger 470 is housed inside a heat insulating container (a second heat insulating container) 410 on the outside together with a vaporizing section 440 and a reforming section 460, in the fuel cell device 401.

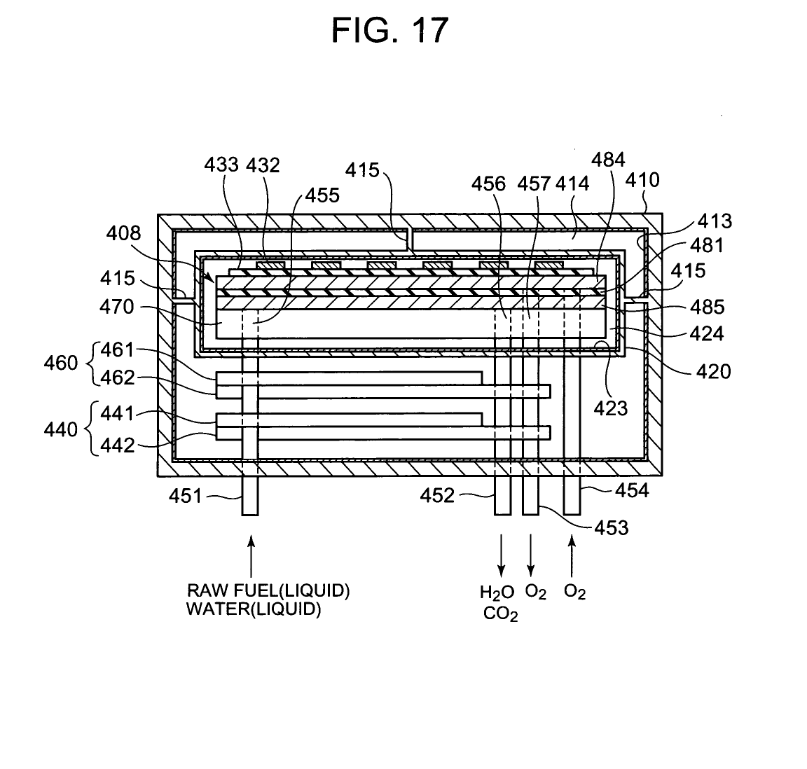

FIG. 17 is a schematic view showing the internal structure of the heat insulating container 410. As shown in FIG. 17, the internal wall surface of the heat insulating container 410 is provided with a first infrared ray reflecting film 413. The heat insulating container 420 is disposed in an inner side of the first infrared ray reflecting film 413 with an air gap 414 formed between them, and an infrared ray reflecting film 423 is provided on the internal wall surface of the heat insulating container 420. The heat insulating container 420 is supported by, for example, supporting members 415 projecting from the internal wall of the heat insulating container 410. The supporting members 415 are made of the same material as those of the heat insulating containers 410 and 420. Incidentally, an infrared ray reflecting film 424 may be provided on the external wall surfaces of the fuel cell 408 and the heat exchanger 470, too through an insulation film 433. In the same manner as the above described first embodiment, because the insulation film 433 exists, the infrared ray reflecting film 424 is not conducted to a thin film heater 432, the fuel electrode separator 484, and the oxygen electrode separator 485.

The sealed box-shaped heat insulating container 410 and 420 are kept to be lower than the atmospheric pressure (for example, 10 Pa or less). The vaporizing section 440 and the reforming section 460 are disposed in the air gap 414 between the heat insulating containers 410 and 420. The fuel cell 408 and the heat exchanger 470 are disposed in an air gap 424 in an inner side of the infrared ray reflecting film 423 of the heat insulating container 420.

A fuel supplying pipe 451 to supply the mixed liquid to the vaporizer 441, gas exhausting pipes 452 and 453 to exhaust the exhaust gas that has passed through heat exchangers 462 and 442, and an air supplying pipe 454 to supply air to the heat exchanger 470 penetrate the same wall surface of the heat insulating container 410. Moreover, a reformed gas supplying pipe 455 to supply a reformed gas from a reformer 461 to the fuel cell 408, gas exhausting pipes 456 and 457 to supply the exhaust gasses 1 and 2, respectively, from the fuel cell 408 to the heat exchangers 462 and 442, respectively, and the air supplying pipe 454 penetrate the same wall surface of the heat insulating container 420.

In this manner, the fuel cell 408 and the heat exchanger 470, the reaction temperatures of which are within a range from about 500° C. to about 1,000° C., are disposed inside the heat insulating containers 410 and 420, and an Au film which is a infrared ray reflecting film, is provided inside of each of the containers 410 and 420. Thereby, the loss of heat caused by radiation can be reduced, and the heat-insulating efficiency of the fuel cell device can be heightened. Moreover, the air gap 414 formed between the heat insulating containers 410 and 420 enables inhibiting the loss of heat so as to be low caused by the heat conduction of a solid from the heat insulating container 420 to the heat insulating container 410.

### <Modification 1>

Because heat is conducted from the pipes to the walls, such as the wall of the heat insulating container 410, which the pipes 451-454 penetrate, and the wall of the heat insulating container 420, which the pipes 454-457 penetrate, a temperature difference is produced between each, of the vicinities of the parts where the pipes penetrate the walls and each of the peripheries of the parts, and a thermal stress operates. Accordingly, a heat dissipation accelerating section to relieve the temperature difference may be provided in the vicinity of each of the parts where the pipes penetrate.

The heat dissipation accelerating section is an area having an infrared ray absorptivity higher in comparison with the other areas of the internal wall surfaces of the heat insulating containers 410 and 420. The heat dissipation accelerating section absorbs the infrared rays radiated from the fuel cell 408, and reactors such as the reformer 461 and the vaporizer 441 to conduct heat to the heat insulating containers 410 and 420 as radiant heat. It hereby becomes possible to raise the temperature of the entire wall on which the heat dissipation accelerating sections are provided, to settle the temperature difference, and to reduce the thermal stress.

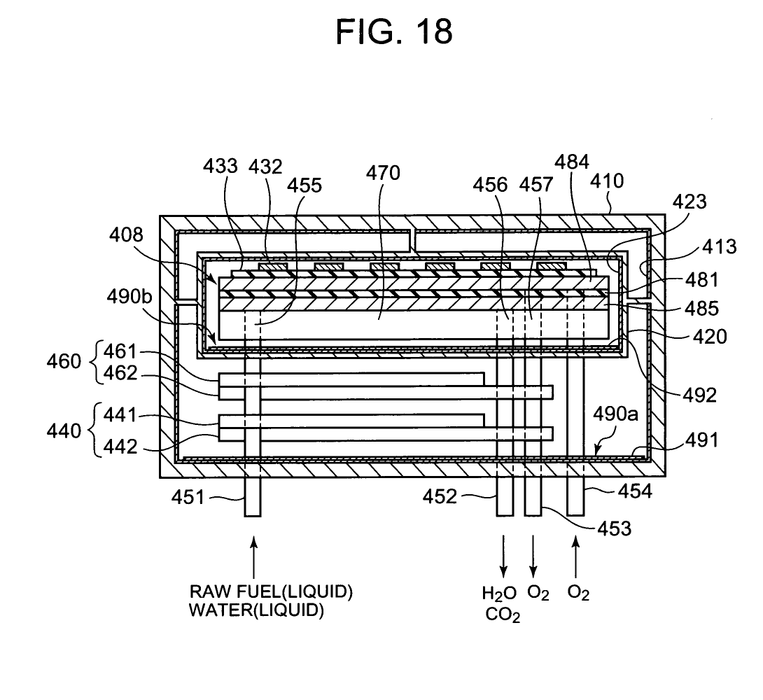

For example, as shown in FIG. 18, heat dissipation accelerating sections 490a and 490b can be formed by further providing absorbing films 491 and 492 to absorb infrared rays, respectively, so as to be superposed on infrared ray reflecting films 413 and 423, respectively, on the internal wall surfaces of the heat insulating containers 410 and 420 that the pipes 451-454 and 454-457 penetrate, respectively.

Here, Rh which has a relatively low reflectance of the infrared ray in a wavelength range of 1 μm or longer, can be a candidate of the materials of the absorbing films 491 and 492 (see FIG. 4).

In addition, Fe (reflectance: 75%), Co (reflectance: 78%), Pt (reflectance: 78%), Cr (reflectance: 63%) or the like, can be used as the materials of the absorbing films 491 and 492 as the metals having low reflectances at the wavelength of 1.24 μm.

Moreover, there is graphite (layered carbon) as a material that is a semimetal and has a low reflectance. The reflectances of the graphite are small, such as 42% at the wavelength of 1.24 μm and 47% at the wavelength of 2 μm, and consequently the graphite can be used as the material of the absorbing films 491 and 492. Moreover, because a carbon material called as activated carbon has poor crystallinity and a disordered layer structure, the activated carbon can also be used as the material of the absorbing films 491 and 492.

Moreover, there is a film made of a Ta—Si—O—N based amorphous semiconductor material as a material that is a nonmetal and has a low reflectance. A Ta—Si—O—N film having a resistivity of 1.0 mΩ·cm has an absorption coefficient of 100,000/cm or more within a range of wavelength from about 2.48 μm to about 350 nm, and can be used as the material of the absorbing films 491 and 492.

Furthermore, the present applicant found that the Ta—Si—O—N film of a composition of molar ratios within the ranges of 0.6<Si/Ta<1.0 and 0.15<N/O<4.1 had an absorption coefficient of 100,000/cm or more when the resistivity thereof was 2.5 mΩ·cm or less. Consequently, the above material can also be used as the material of the absorbing films 491 and 492.

The infrared rays radiated from the fuel cell 408, and the reactors such as the reformer 461, and the vaporizer 441 or the like, are absorbed by the heat dissipation accelerating sections 490a and 490b, and the absorbed infrared rays are transmitted to the heat insulating containers 410 and 420 as radiant heat. Consequently, the temperature of the entire wall on which the heat dissipation accelerating sections 490a and 490b are provided can be uniformly raised. The temperature differences between the parts where the pipes 451-454 penetrate the heat insulating container 410 and the parts inside the heat insulating containers 420 can be hereby settled to reduce the thermal stress.

### <Modification 2>

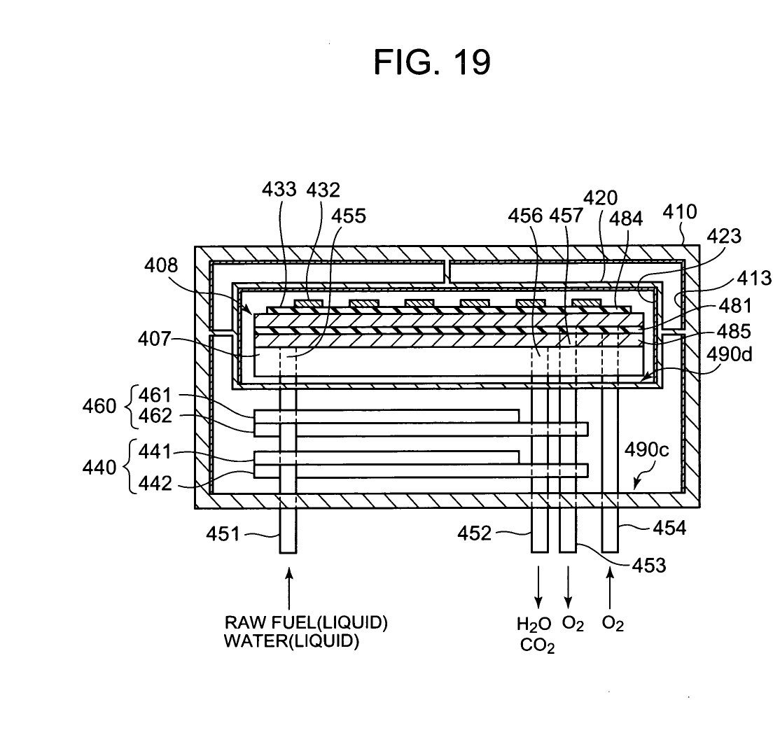

Incidentally, as shown in FIG. 19, the parts of the internal wall surface of the heat insulating container 410 that the pipes 451-454 penetrate and the parts of the internal wall surface of the heat insulating container 420 that the pipes 454-457 penetrate may be used as heat dissipation accelerating sections 490c and 490d, respectively, by exposing their underlying materials without covering the parts by the infrared ray reflecting films.

### <Modification 3>

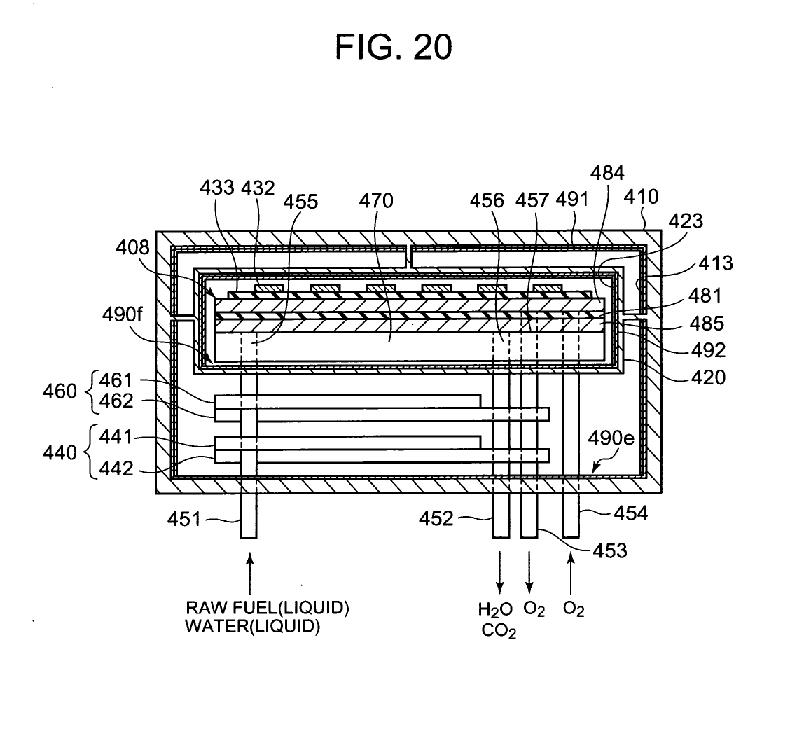

Moreover, as shown in FIG. 20, the parts where the absorbing films 491 and 492 are exposed from the infrared ray reflecting films 413 and 423, respectively, may be used as heat dissipation accelerating sections 490e and 490f, respectively, by providing the absorbing films 491 and 492 on the entire surface of the internal wall surfaces of the heat insulating containers 410 and 420, respectively, and by providing the infrared ray reflecting films 413 and 423, respectively, of the internal wall surfaces of the heat insulating containers 410 and 420, respectively, except for the parts where the pipes 451-454 penetrate the internal wall of the heat insulating container 410 and for the parts where the pipes 454-457 penetrate the internal wall of the heat insulating container 420.

### <Modification 4>

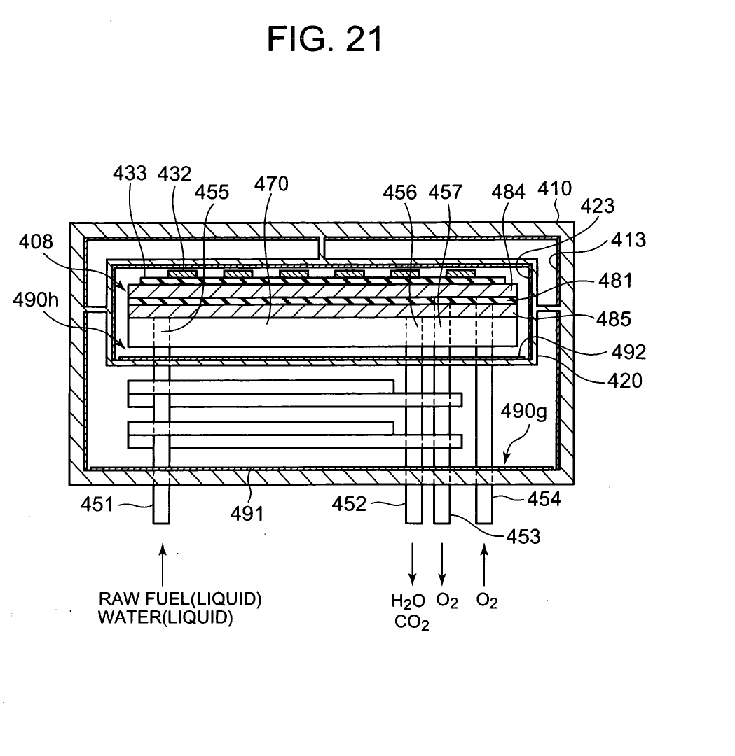

Moreover, as shown in FIG. 21, the parts where the absorbing films 491 and 492 are provided may be used as heat dissipation accelerating sections 490g and 490h, respectively, by providing the absorbing films 491 and 492, respectively, to the parts of the internal wall surfaces of the heat insulating containers 410 and 420, respectively, in which the pipes 451-454 penetrate the internal wall of the heat insulating container 410 and the pipes 454-457 penetrate the internal wall of the heat insulating container 420, and by providing the infrared ray reflecting films 413 and 423, respectively, to the other parts. In this case, the peripheries of the absorbing films 491 and 492 and the infrared ray reflecting films 413 and 423 may be superposed, respectively.

Incidentally, the wall surface of the internal wall surface of the heat insulating container 410 that the pipes 451-454 penetrate and the wall surface of the internal wall surface of the heat insulating container 420 that the pipes 454-457 penetrate are not limited to one surface of each of the heat insulating containers 410 and 420, but may respectively be divided into a plurality of surfaces to be penetrated. In that case, when at least the vicinity of the part that each pipe penetrates in each penetrated surface is used as a heat dissipation accelerating section, then the same effects as those of the modifications mentioned above can be obtained. Moreover, in this case, it is sufficient to make each heat dissipation accelerating section have an infrared ray absorptivity higher than those at the other parts, and it is not always necessary to make the infrared ray absorptivity of each heat dissipation accelerating section equal. Consequently the configuration in which the internal wall surface of each heat insulating container includes three or more types of areas mutually different in the infrared ray absorptivity may be adopted.

What is claimed is:

1. A fuel cell device, comprising:
a fuel cell to extract electric power by an electrochemical reaction of a fuel and oxygen;
a heat exchanger to heat a fluid to be used for the fuel cell by heat of the fuel cell; and
a heat insulating container to house the fuel cell and the heat exchanger.

2. The fuel cell device according to claim 1, wherein the fluid is heated by the heat exchanger before the fluid is used for the fuel cell.

3. The fuel cell device according to claim 1, wherein the fluid is the fuel.

4. The fuel cell device according to claim 1, wherein the fluid is the oxygen.

5. The fuel cell device according to claim 1, further comprising a reformer to generate the fuel to be supplied to the fuel cell from a raw fuel, wherein
the fluid is the raw fuel.

6. The fuel cell device according to claim 1, wherein an infrared ray reflecting film having infrared ray reflectance which is higher than that of the heat insulating container is formed on an internal wall surface of the heat insulating container.

7. The fuel cell device according to claim 1, wherein a pressure inside of the heat insulating container is lower than an atmospheric pressure.

8. The fuel cell device according to claim 1, further comprising:
the reformer to generate the fuel to be supplied to the fuel cell from a raw fuel; and
a second heat insulating container to house the heat insulating container and the reformer, wherein
an infrared ray reflecting film having infrared ray reflectance which is higher than that of the second heat insulating container is formed on an internal wall surface of the second heat insulating container.

9. The fuel cell device according to claim 8, wherein a pressure inside of the second heat insulating container is lower than an atmospheric pressure.

10. The fuel cell device according to claim 1, further comprising a combustor in the heat insulating container to combust a raw fuel to generate the fuel or to combust an exhaust gas exhausted from the fuel cell, wherein
the fuel cell is heated by heat of the combustor.

11. The fuel cell device according to claim 1, further comprising:
a pipe which is disposed so as to penetrate the heat insulating container to supply the fluid from an outside of the heat insulating container to the fuel cell, wherein
an internal wall surface of the heat insulating container includes one area having a predetermined infrared ray reflectance, and other area having a lower infrared ray reflectance than the one area, and
the pipe penetrates the other area.

12. The fuel cell device according to claim 1, further comprising:
a pipe which is disposed so as to penetrate the heat insulating container to exhaust an exhaust gas from the fuel cell to an outside of the heat insulating container, wherein
an internal wall surface of the heat insulating container includes one area having a predetermined infrared ray reflectance, and the other area having lower infrared ray reflectance than the one area, and the pipe penetrates the other area.

13. The fuel cell device according to claim 8, further comprising:
a pipe which is disposed so as to penetrate the second heat insulating container to supply the fluid from an outside of the heat insulating container and of the second heat insulating container to the fuel cell, wherein
the internal wall surface of the second heat insulating container includes one area having a predetermined infrared ray reflectance, and other area having a lower infrared ray reflectance than the one area, and
the pipe penetrates the other area.

14. The fuel cell device according to claim 8, further comprising:
a pipe which is disposed so as to penetrate the second heat insulating container to exhaust an exhaust gas from the fuel cell to the outside of the heat insulating container and of the second heat insulating container, wherein
the internal wall surface of the second heat insulating container includes one area having a predetermined infrared ray reflectance, and the other area having a lower infrared ray reflectance than the one area, and
the pipe, penetrates the other area.

15. The fuel cell device according to claim 11, wherein
an infrared ray reflecting film which is made of a material having infrared ray reflectance which is higher than that of the other area is provided in the one area.

16. The fuel cell device according to claim 15, wherein the infrared ray reflecting film includes Au or Ag.

17. The fuel cell device according to claim 11, wherein
an infrared ray absorbing film which is made of a material having infrared ray reflectance which is lower than that of the one area is provided in the other area.

18. The fuel cell device according to claim 17, wherein a main component of the infrared ray absorbing film is any one of C, Fe, Co, Pt, and Cr.

19. The fuel cell device according to claim 17, wherein
the infrared ray absorbing film is a Ta—Si—O—N based amorphous semiconductor,
molar ratios of the infrared ray absorbing film are within ranges of 0.6<Si/Ta<1.0 and 0.15<N/O<4.1, and
an absorption coefficient of the infrared ray absorbing film is 100,000/cm or more.

20. The fuel cell device according to claim 1, further comprising an infrared ray reflecting film on an outer peripheral surface of the fuel cell to inhibit a heat transfer caused by a radiation.

21. The fuel cell device according to claim 1, further comprising:
a valve to change an amount of the fluid to be supplied; and
a control section to change the amount of the fluid to be supplied to the heat exchanger by opening the valve before the fuel cell reaches a predetermined temperature.

22. An electronic equipment comprising:
the fuel cell device according to claim 1; and
an electronic equipment main body which is operated by the electric power generated by the fuel cell device.
